(19) United States
(12) Patent Application Publication
(10) Pub. No.: US 2007/0130518 A1
(43) Pub. Date: Jun. 7, 2007

(54) Method and apparatus for a personalized web page

(75) Inventors: Eli Shavit, Ashqelon (IL); Vitali Polonetzky, Ashqelon (IL); Alexey Nikandrof, Ashqelon (IL); Eran Sides, Tel Aviv (IL)

Correspondence Address: DAVIDSON, DAVIDSON & KAPPEL, LLC, 485 SEVENTH AVENUE, 14TH FLOOR, NEW YORK, NY, 10018, US

(73) Assignee: Alefo Interactive Ltd., Petach Tikva (IL)

(21) Appl. No.: 11/292,864

(22) Filed: Dec. 1, 2005

(51) Int. Cl. G06F 17/00

(52) U.S. Cl. 715/530; 715/513; 715/500

(57) ABSTRACT

A method and apparatus for constructing and using a personalized web page, the personalized web page comprising an at least one module which is a fragment of a second web page having a locator, the second web page stored on a web site, the fragment identified by at least two coordinates within the second web page. The method comprises the steps of selecting the fragment of the second web page, placing the module on the personalized web page; and storing a description of the personalized web page on a server, wherein the description comprises the locator and the coordinates of the fragment of the second web page within the second web page.

### BACKGROUND OF THE INVENTION

1. Field of the Invention

The present invention relates to a method and apparatus for generating a personalized web page in general, and to creating a personalized portal containing only data of interest for a user in particular.

2. Discussion of the Related Art

Internet users have different preferences for their home page, i.e., the first web page that loads when they start surfing the Internet. Many users use a portal as their home page. A portal is usually a home page belonging to a site, which contains various data items, such as texts, pictures and links to other pages within that site or at other sites. Some portals are freely accessible for anyone, while others are specific and only a group of users, for example the employees of a corporation, are allowed to access them. However, in all these cases, the user is limited to the contents and layout as chosen by the manager of the site, and can not freely choose contents from different sites that are of interest, and certainly not their layout. The user can not view simultaneously data from multiple web pages, for example the home page of his favorite sports team, and the news headlines from another site.

Alternatively, a user can design a web page and make it his or her home page, but this requires certain abilities and some effort on the side of the user, and is limited in the types, layout and composition of contents that can be presented.

There is therefore a need for an apparatus and method that will enable a user to easily construct a personalized web page that can serve as his or her home page. The user should be able, without having to program or to use complex systems, to construct a page which contains data from multiple sources, utilities, and other items, and to design the page in any desired layout.

### SUMMARY OF THE PRESENT INVENTION

It is an object of the present invention to provide a novel method for detecting performance deficiencies of an operational environment, which overcomes the disadvantages of the prior art.

In accordance with the present invention, there is thus provided a method for constructing and using a personalized web page, the personalized web page comprising one or more first modules, each first module being a fragment of a second web page having a locator and stored on a web site, the fragment identified by two or more coordinates within the second web page, each coordinate comprising two numbers, the method comprising the steps of selecting the fragment of the second web page; placing the first module on the personalized web page; and storing a description of the personalized web page on a storage device. Within the method, the description of the personalized web page can comprises the locator of the second web page and the coordinates of the fragment of the second web page, within the second web page. The locator can be a Unified Resource Locator. The method can further comprise the steps of retrieving the description of the personalized web page from the storage device; loading the second web page; and clipping the second web page according to coordinates of the fragment of the second web page. Within the method, the second web page is loaded from the web site. Within the method, the personalized web page is a home page or a personalized portal. The first module can be collapsed, expanded, placed on an icon tray, or retrieved from the icon tray. The first module can be refreshed at predetermined intervals. Within the method, the personalized web page can comprise one or more second modules. The method can further comprise the step of presenting the second modules on the personalized web page. Each second module is a utility, which can be one of the group consisting of: a clock; a world clock; a calendar; a holiday and special times utility; a chat tool; a radio-like or TV-like tool; a media guide; a bills payment service; a postal delivery service; a price comparing tool; a phone directory; an SMS or MMS sending tool; a translator or a trans-literature tool; a downloading tool; a weather reporting tool; a calculator of any type, including a scientific calculator, an economics calculator and others; an e-mail checking utility; a maps utility; a currency exchange and conversion rates tool; a memo pad; a search engine; a stock quote tool; or a domain-specific utility. Each second module can be an RSS feed. Each second module can be collapsed, expanded, placed on an icon tray, or retrieved from the icon tray. Each second module can be refreshed at predetermined intervals. Within the method, the personalized web page can be used as an active desktop. The personalized web page can be viewed from a platform, the platform is can be a personal computer; a network computer; a laptop computer; a handheld device; or a cellular phone.

Another aspect of the disclosed invention relates to an apparatus for constructing and presenting a personalized web page, the personalized web page comprising one or more first modules, each first module is a fragment of a second web page having a locator, the fragment identified by at two or more coordinates within the second web page, wherein each coordinate comprises two numbers, the apparatus comprising: a storage device for storing the locator of the second web page and the coordinates; and a server platform, the server platform comprises a network importing component for selecting and submitting the locator of the second web page and the coordinates of the fragment of the second web page to the personalized web page; and a module addition component for adding the first modules to the personalized web page. The server platform can further comprise a component for enabling drag and drop operations. The server platform can further comprise a component for handling operations related to one or more users of the apparatus. Within the apparatus, the locator of the second web page can be a Unified Resource Locator.

Yet another aspect of the disclosed invention relates to a computer readable storage medium containing a set of instructions for a general purpose computer, the set of instructions comprising: a selection component for selecting a fragment of a first web page; a placement component for placing the fragment of the first web page on a personalized web page; and a storage component for storing a description of the personalized web page on a server.

### BRIEF DESCRIPTION OF THE DRAWINGS

The present invention will be understood and appreciated more fully from the following detailed description taken in conjunction with the drawings in which:

FIG. 1 is a schematic illustration of a personalized portal constructed in accordance with the disclosed invention;

FIG. 2 is a schematic block diagram of a typical environment in which the disclosed invention is used;

FIG. 3 is a schematic illustration of the option to choose a predefined RSS feed component to be added to the personalized portal, in accordance with the disclosed invention;

FIG. 4 is a schematic illustration of the option to choose a predefined utility to be added to the personalized portal, in accordance with the disclosed invention;

FIG. 5 shows a selected rectangle of a web page, in accordance with the disclosed invention;

FIG. 6 shows a personalized portal comprising the rectangle of FIG. 5, in accordance with the disclosed invention;

FIG. 7 shows an icon tray comprising miniaturized components, in accordance with the disclosed invention;

FIG. 8 shows an active desktop generated from the personalized web page, in accordance with the disclosed invention;

FIG. 9 is a flow chart of the main steps in constructing and viewing a personalized web page; and

FIG. 10 shows the main components of the system, in accordance with the disclosed invention.

### Definitions

Site shot—presenting a fraction of a web page within a page constructed in accordance with the disclosed invention;

RSS—Rich Site Summary: an XML-based format, using the Resource Description Framework (RDF)—that allows the syndication of lists of hyperlinks, along with other information, or metadata. RSS allows a person's browser to fetch and understand the information, so that all of the lists that person is interested in can be tracked and personalized for them, subject to certain conditions such as mentioning the source of the information.

### DETAILED DESCRIPTION OF THE PREFERRED EMBODIMENT

The present invention overcomes the disadvantages of the prior art by providing a novel method and a system which enables a user to build his or her own web page and preferably use it as a personal portal. The web page is designed according to the user's preferences, and can contain various types of modules or components, and information from multiple sources. The modules can be, but are not limited to one or more fragments of any web page, RSS feeds, utilities, or other components. For example, a user can construct a personal portal comprising the top story from the web site of his favorite sports team, which can usually be found on the top left corner of the team's home page, news feeds from his favorite news site, a weather forecast, a sticker-like utility which is an editable textual memo, a calendar, a calculator or the like. The description of a specific user's web page is stored on a server and is associated with the user's name, so that the user can access his page from multiple computers. However, no content from other web pages is stored on the server implementing the disclosed invention. Once the user loads the web page to his browser, the browser accesses the web sites directly to get the information. In the case of RSS feeds, the browser accesses directly the relevant web site providing the feeds. Only the address of the page and the coordinates of the fragment selected by the user are stored on the server. In the case of rectangular fragments of a web page, the coordinates comprise two coordinates, denoting any two opposite corners of the rectangle, wherein each coordinate comprises two numbers, denoting the horizontal and vertical dimensions of the coordinate. When loading such a page, preferably the whole page is loaded and clipped according to the desired coordinates. Alternatively, only the relevant fragment of the web page is loaded by the server implementing the disclosed invention. The user can design the personal portal freely or along grid lines, and can also minimize or edit one or more items. The one or more items can also be minimized into a tray icon which is always accessible. The system enables any combination of languages, both for the presented modules and components, and for the interfaces used by a user of the invention.

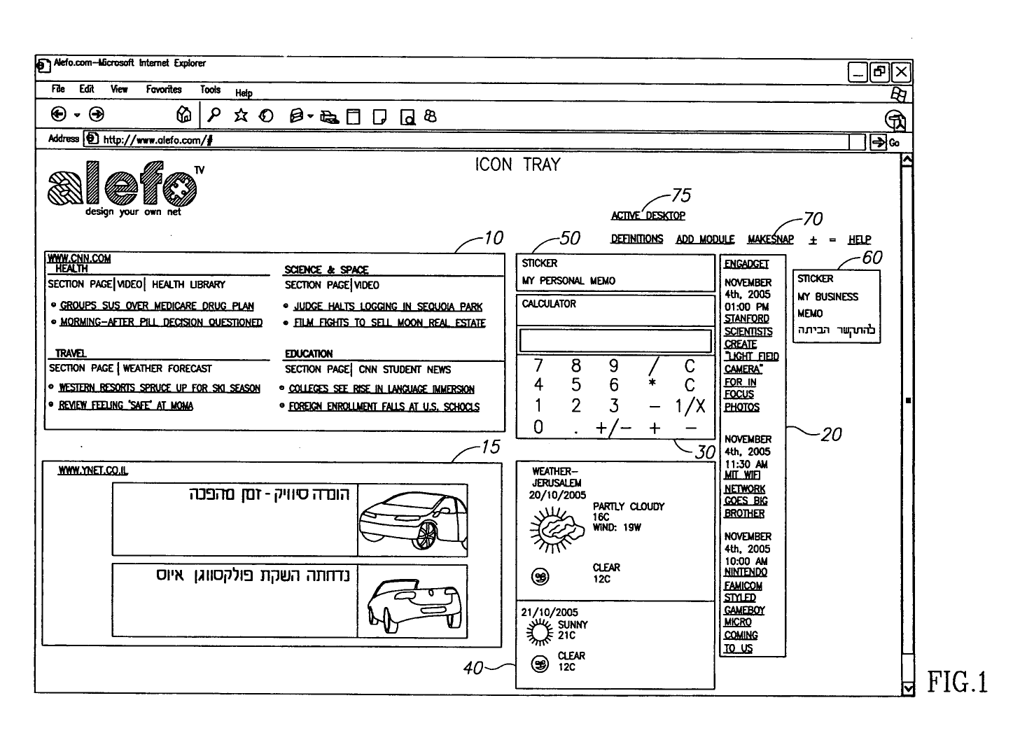

Referring now to FIG. 1, showing a personal web page, comprising a part 10 from a web page in a first language, a part 15 from a web page in a second language, a news feed (RSS) from another page 20, a calculator 30, a whether forecast 40, and two memos: a personal one 50, and a business one 60. In accordance with a preferred embodiment, each component of the page is editable, according to relevant parameters. For example, RSS feed 20 can be configured to show any number of news items, whether component 40 can be configured to show the weather in a certain city and for a certain number of days, and the like. Since the personalized page uses Unicode encoding for text, the page can simultaneously comprise items in multiple languages. For example, the page shown in FIG. 1 comprises content in a first language, English, in most items, and content in a second language in item 60. Each item on the page can be collapsed, expanded, or sent to the icon tray. The personalized web page further comprises “makesnap” button 70. Adding the code associated with this button to the list of favorite addresses (for example, by right-clicking the button and choosing the option of “Add to Favorites”) enables the user to later capture fragments of other web pages and paste them into a personalized web page. The personalized web page also comprises an active desktop button 75. Pressing button 75 causes the modules currently residing on the personalized web page to be placed on the desktop of the user.

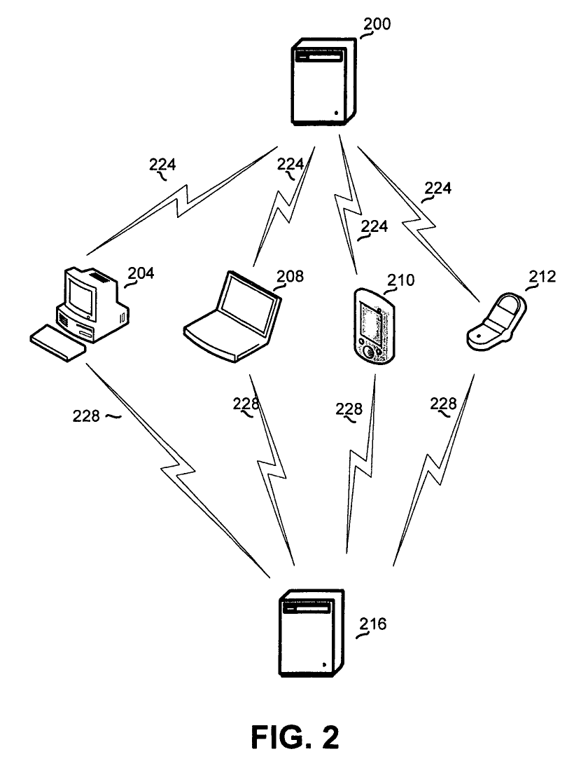

Referring now to FIG. 2, showing a typical environment of the disclosed invention. The core of the system is server 200, which is preferably a computing platform, such as a personal computer, a mainframe computer, or any other type of computing platform that is provisioned with a memory device (not shown), a CPU or microprocessor device, and several I/O ports (not shown). Alternatively, server 200 can be a DSP chip, an ASIC device storing the commands and data necessary to execute the methods of the present invention, or the like. Server 200 further comprises, or connects to one ore more storage devices (not shown), storing the relevant applications, which are sets of logically inter-related computer programs and associated data structures. The storage is further used to store the descriptions of the pages constructed by the users of the system. Each storage device can be a magnetic tape, a magnetic disc, an optical disc, a laser disc, a mass-storage device, or the like. The users use the systems via one or more clients, which are also computing platforms. The client platform is preferably a personal or network computer 204, a laptop computer 208, a handheld device, such as a palm 210, a cellular phone 212, or any other platform provisioned with communication and computerized capabilities. The apparatus further comprises multiple web servers 216 hosting web pages, including portals or other sites. The user, using a personal computer 204, a laptop computer 208, a handheld device 210, or a cellular phone 212 communicates 224 with server 200 of the apparatus, which supports the building, storing and retrieval the personalized web page of the user. The user also communicates 228 with the various web sites from which he or she wishes to present information. As shown in FIG. 2, server 200 does not communicate with content servers 216, and does not store content taken from servers 216. It stores merely links to these sites and optionally the coordinates associated with web pages stored on these servers. Communication means 224 and 228 can use any currently known communication protocols, such as http, FTP, or other protocols currently known or that will become known in the future. The user's devices are not limited to the presented personal computer 204, a laptop computer 208, a handheld device 210, or a cellular phone 212, but can also be any other device currently known or that will be available in the future.

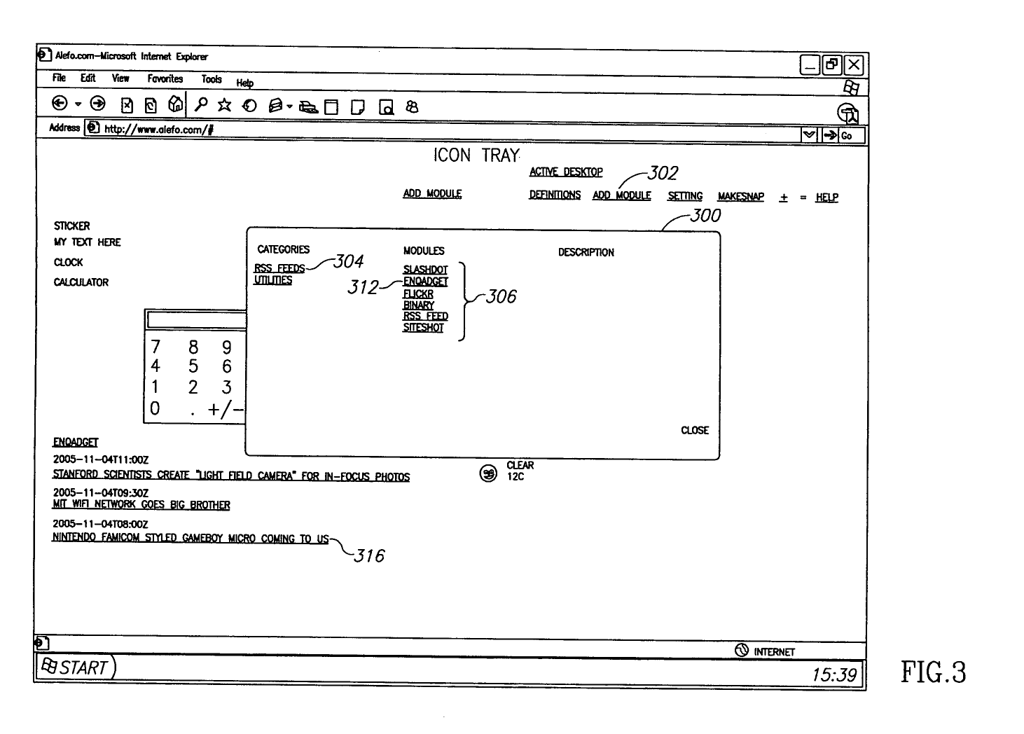

Reference is now made to FIG. 3, showing the option to add one or more RSS feeds to the personalized web page. Many sites, such as portals, supply one or more RSS feeds. RSS stands for Rich Site Summary, and using RSS enables the importation of data items in format of headlines to a web page, possibly under some terms, such as mentioning the site's name or the like. In FIG. 3, window 300 was opened when the user clicked on add module button 302. Window 300 enables the addition of RSS feeds or utilities to the constructed web page. The user clicked on “RSS Feeds” button 304, and received the list of available RSS feeds 306 on the right hand side of the window. The list includes the RSS feeds suggested by the server of the disclosed apparatus, including, for example ENQADGET 312 which was already brought into the web page and can be seen on RSS pane 316 on the lower left corner of the web page. Once the user closes window 300, he or she can click on the edit button of pane 316 (not seen), and change the configuration, including for example, the presented number of items. The RSS feeds are converted by the disclosed apparatus from the format supplied by the RSS source, into the format used by the browser.

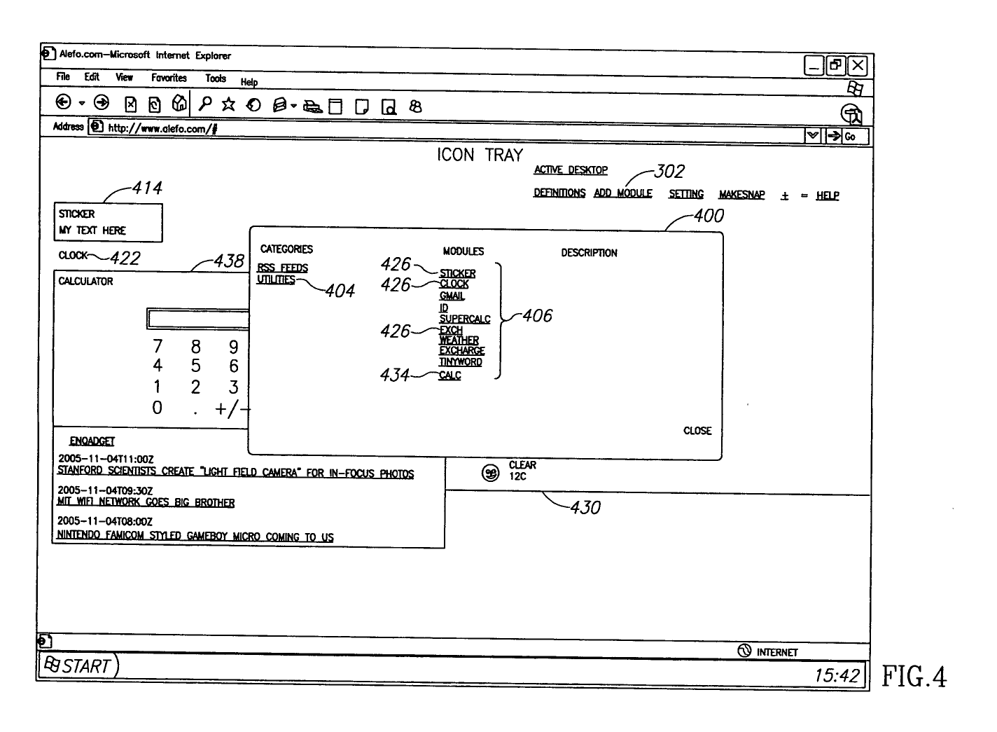

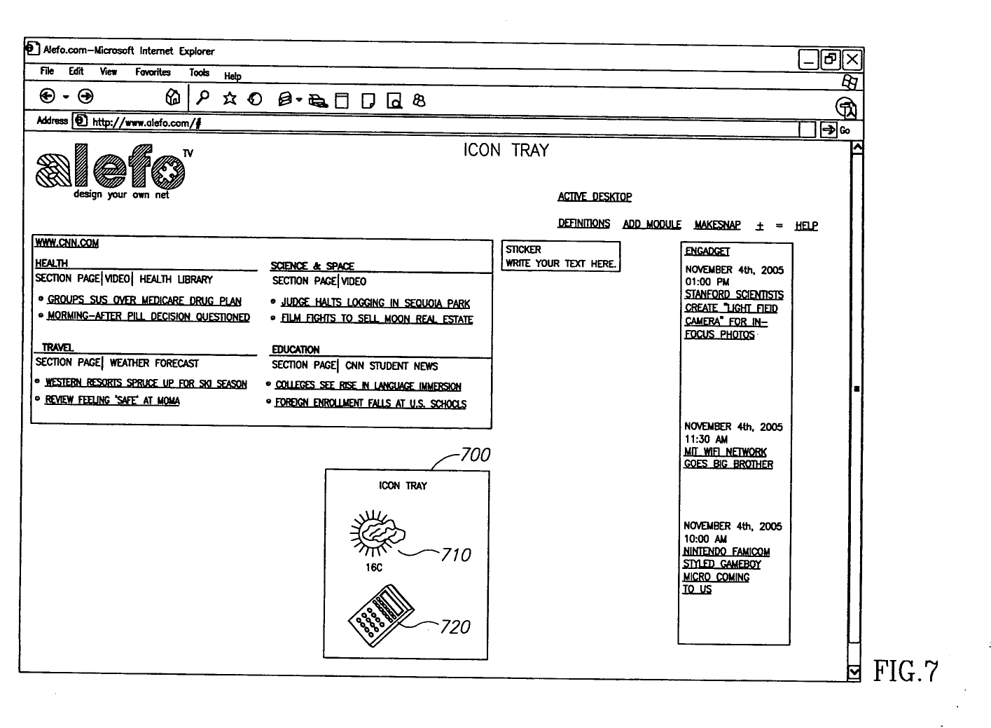

Referring now to FIG. 4, showing the addition of one ore more utilities to the personalized web page. In FIG. 4, window 400, which appears when the user clicks on Add Module button 302, enables the addition of one or more utilities to the web page. The user clicked on “Utilities” button 404, and received the list of available utilities 406 on the right hand side of the window. The list includes the utilities suggested by the server of the disclosed apparatus, including, for example sticker 410 which can be seen in pane 414, clock 418 which is collapsed pane 422, weather utility 426 seen in pane 430 and calculator utility 434 shown in pane 438. Adding a utility to the web page runs the code implementing that utility on the server to the web page, so that when the page is displayed, the code is activated, and the utility is presented and functioning. The user can move, resize, collapse, or expand any utility. The user can further change the utility according to relevant options, for example show a calculator in a normal or in a scientific configuration. The user can further move any utility to the icon tray, detailed in association with FIG. 7 below.

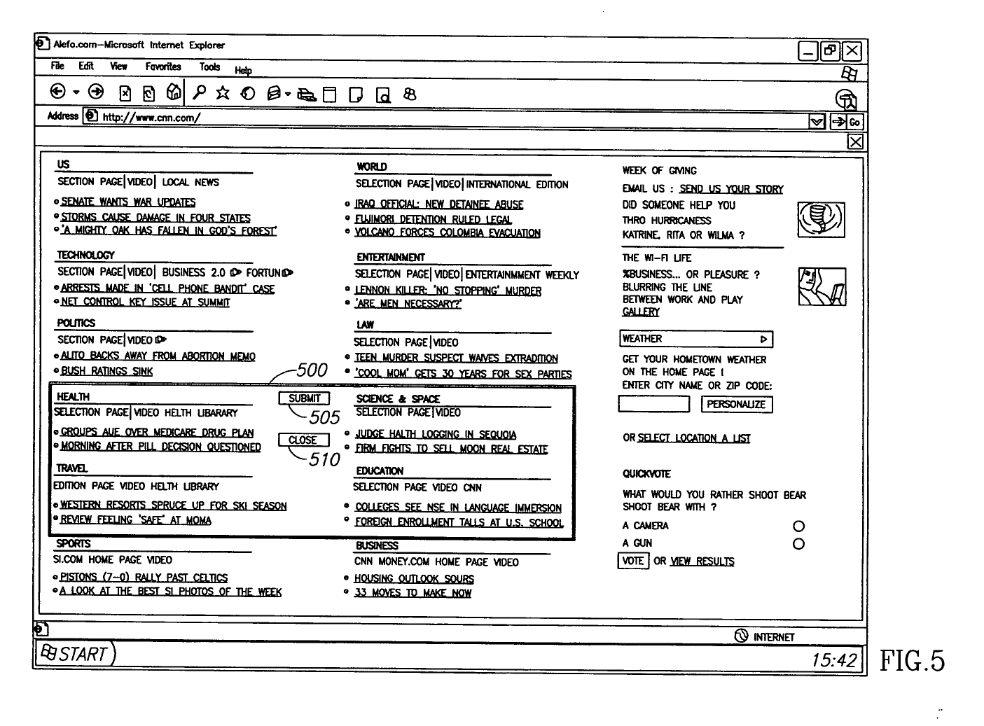

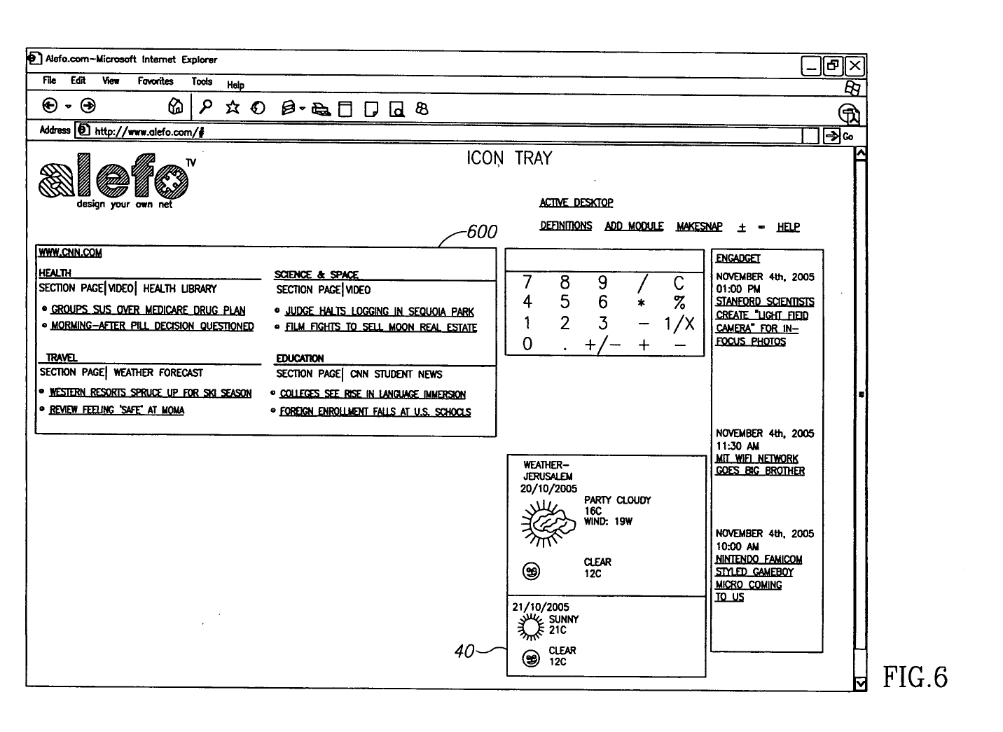

Referring now to FIGS. 5 and 6, showing the option of adding a site shot, i.e. a fragment of a web page to a personalized web page.

FIG. 5 show a regular web page, a part of which the user wishes to bring to his or her personalized web page. Once he desired page is presented, the user activates the “site shot” option, by running, for example, a code fragment which was earlier stored in the “favorites” of the browser. Then the user is allowed to choose an area of the screen, preferably but not limited to a rectangular area, for example area 500 in FIG. 5. In a preferred embodiment, the area is selected by clicking down the left mouse button on the top left corner of the desired area, dragging the mouse to the bottom right corner and then releasing the left mouse button. Once the button is released, the user can resize, move or otherwise change the selected rectangle. Once the button is released, the option to insert the selected part of the page is enabled. In the preferred embodiment, “submit” button 505 appears, which when clicked adds the relevant area to the personalized web page. When the user clicks “close” button 510, the selection is de-selected and buttons 505 and 510 disappear. FIG. 6 presents the personalized web page, including the relevant part of the page shown in FIG. 5, in pane 600. Server 200 of FIG. 2, which stores or connects to a storage of the personalized web pages stores merely a locator, such as the Uniform Resource Locator (URL) of the web page, and the coordinates of the area selected by the user. Any other currently known web page locator, or a locator that will become known later can be used for storage. The coordinates of the selected fragment within the page can be, for example, the coordinates of the top left and the bottom right points of the fragment. The content of the web page itself are not loaded to the server of the disclosed invention (server 200 of FIG. 2), but is loaded by the browser every time the personalized web page is refreshed, or every configurable time interval. Then the browser clips the contents of the page according to the stored coordinates, and presents just the clipped area. As can be seen from comparing FIG. 5 and FIG. 6, the coordinates of part 500 within the web page shown in FIG. 5 are not related to the coordinates of part 600 within the personalized web page shown in FIG. 6. In a preferred embodiment of the disclosed invention, the code which implements the addition of the page part to the personalized web page is:

javascript:uid=‘1’;
(function( )
{

s=document.createElement(‘script’);
s.type=‘text/javascript’;
s.id=‘_alefo_script’;
s.src=‘http://www.alefo.com/modules/siteshot/siteshot.js.php?uid=’+uid;
document.body.appendChild(s);

})( );

In a preferred embodiment of the disclosed invention, the server screens the web page chosen by the user, excluding the area selected by the user, so that only that area is shown on the personalized web page.

Persons skilled in the art will appreciate that other implementations of the submission exist, and further ones might exist in the future.

Referring now to FIG. 7, which shows the usage of Icon Tray 700. In FIG. 7, icon tray 700 comprises weather tool 710 and calculator 720, which were earlier dragged into the icon tray. When an object, such as a utility resides in the icon tray, it does attempt to show some details, for example the current temperature associated with the settings of the weather tool. Any RSS feed, utility, part of page, or another element can be dragged into or out of the icon tray. The icon tray can be moved around and placed anywhere on the personalized web page.

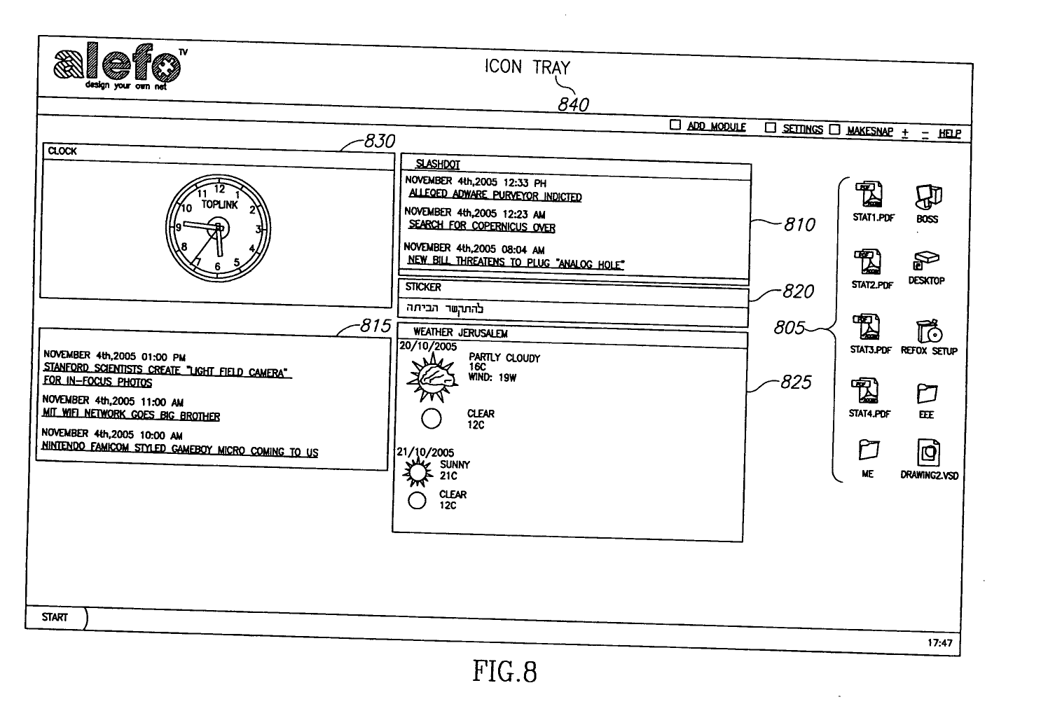

Referring now to FIG. 8 which shows an active desktop of a user's computer, generated by pressing the active desktop button 75 of FIG. 1. Please note that FIG. 8 was generated from a different personalized web page than the one shown in FIG. 1, and therefore contains different modules. In addition to icons 805 which are an ordinary part of a desktop of a personal or a network computer, the active desktop shown in FIG. 8 comprises RSS feeds 810 and 815, memo note 820, whether forecast 825 and clock 830. Any of these items is functional, and can be resized, moved, collapsed, put on icon tray 840 on the desktop, or otherwise manipulated in the same manner as on the personalized web page.

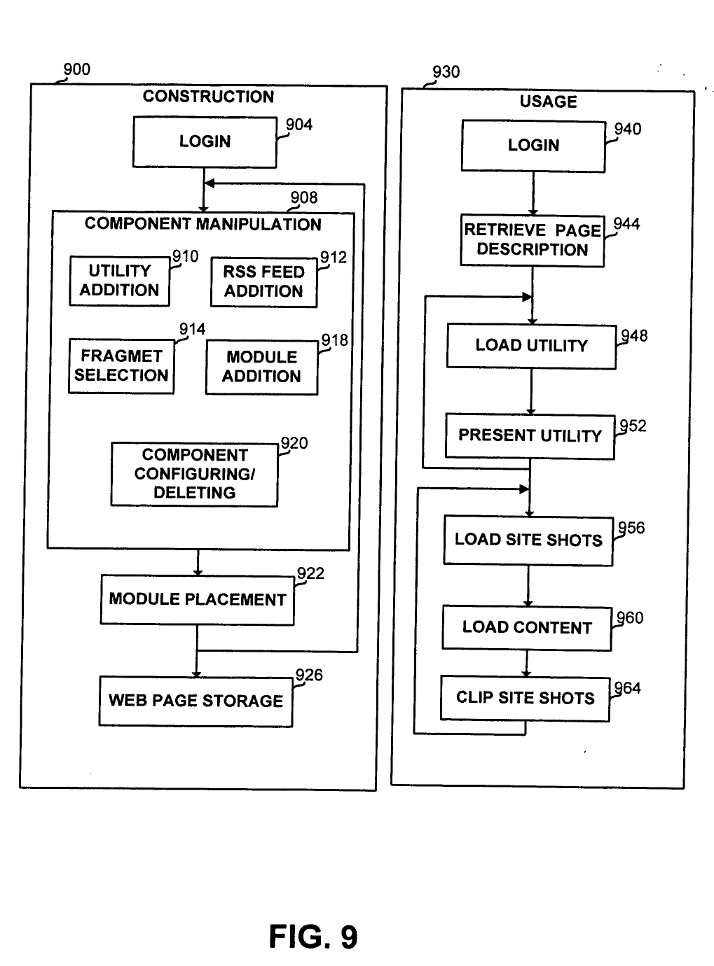

Referring now to FIG. 9, showing the main steps associated with the method of the disclosed invention. At step 900 the page is constructed, and at step 930 it is used. Construction step 900 includes login to the system at step 904, in which the user identifies to the system and is preferably requested to supply a password. Preferably, the system stores session variables in a persistent cookie, so when the user reloads the personalized page after the session has expired, the session variables are reloaded from the cookie, as if the continues the navigating in the site using the same session. Preferably, the IP address of the computer the user is using is not referred to, so that a person can access the same personalized page from multiple computing platforms, including his or her cellular phone, handheld device, laptop computer or the like. In addition, the user can logout and login under a different name, for example when the same platform is used by multiple users. Then, at step 908, the user manipulates the modules he or she wishes to have on the web page. The manipulation can include adding a utility at step 910, as was discussed in association with FIG. 3 above, or component configuring or deleting at step 920. The utilities can include a clock; a world clock; a calendar; a holiday and special times utility; a chat tool for chatting with other users of the disclosed invention; a radio-like or TV-like tool; a media guide; a bills payment service; a postal delivery service; a price comparing tool; a phone directory; an SMS or MMS sending tool; a translator or a trans-literature tool; a downloading tool; a weather reporting tool; a calculator of any type, including a scientific calculator, an economics calculator and others; an e-mail checking utility; a maps utility; a currency exchange and conversion rates tool; a memo pad; a search engine; a domain-specific utility; such as a stock quote tool, or any other utility. The utilities can be supplied by a server of the disclosed invention, or can be implemented and used by any user. At step 912 the user can add an RSS feed component. The source of the RSS feed can be chosen from the RSS feeds suggested by the server, or from any site offering the RSS service. At step 914 the user selects one or more fragments of one or more web pages, i.e. site shots, to be added to the personalized web page. The siteshot is a rectangular fragment of a specific web page. For that end, the user loads the web page, activates a component that first enables the selection of rectangle, the resize or moving of the rectangle, and then provides a “submit” option. When the user selects the “submit” option, the address of the web page and the coordinates of the rectangle chosen by the user are submitted to the server of the disclosed invention and stored there. It is important to note that no content from the web page is transmitted to or stored by the server, but only the address and the coordinates of the required fragment within the web page, which are not to be confused with the coordinates in which the fragment is placed within the personalized web page. The loading of the content is explained at step 960 below. At step 918 additional types of modules, currently known or that will become known in the future are added to the web page. At step 920 any component on configured according to its type, or removed from the page. At step 922, the user can manipulate the modules on the page, resize, move, miniaturize, enlarge, add to the icon tray or retrieve from the icon tray any component of the page. Alternatively, the system can place the modules on the web page, and the user can then change the placement according to his or her preferences. The system preferably updates the server after every change to the page, but can alternatively update the server only when the user explicitly asks to do so. The user can use an option to snap the objects to a grid, or can place them freely over the page at any desired layout. The server optionally parses the elements and their locations, thus constructing and saving it in any adequate format, such as XML, HTML or any other. At step 926, the description of the web page is stored on the storage device associated with server 200 of FIG. 2. Alternatively, the storage step takes place after each change to the personalized web page, i.e. after each addition, deletion, change, or the like. At step 930, the user uses, i.e., loads the personalized web page he or she constructed at step 900. This step optionally involves logging into the system at step 940, similarly to step 904 above, and then loading the description of the stored web page at step 944. As mentioned above, the page is preferably stored at the server in HTML, XML or any another format. Once the page is loaded, each element is loaded according to its type. At step 948 each utility is loaded from the server, or from any other location it is stored at. At step 952, the utility is presented, preferably taking into account its settings. For example, a calculator can be presented as simple or as scientific. Steps 948 and 952 are performed for all utilities on the personalized web page. At step 956, one site shot is loaded, i.e., the link and the coordinates are received from the server. Then, the browser accesses directly the web site associated with the site shot, loads the contents of the web page at step 960, and clips the web page so that only the part of the page which is bounded by the coordinates at step 964 is presented. Steps 956, 960, and 964 are performed for all site shots of the web page. It would be clear to a person skilled in the art that the relative order, in which the utilities and the site shots are presented, is set by the browser. In an alternative embodiment, the order can be set by an apparatus implementing the disclosed invention.

In an alternative embodiment of the presented steps can also be implemented, wherein the web page elements are loaded in a different manner, such as one at a time according to the order in which they are supplied by the server, and not necessarily a sequence of all the utilities and then a sequence of all the site shots. The steps presented above or their order is not mandatory. A person skilled in the art would appreciate that an implementer of the invention can divide the basic operations of adding, changing, or deleting page elements into different steps, and a user of the invention can use them in arbitrary order.

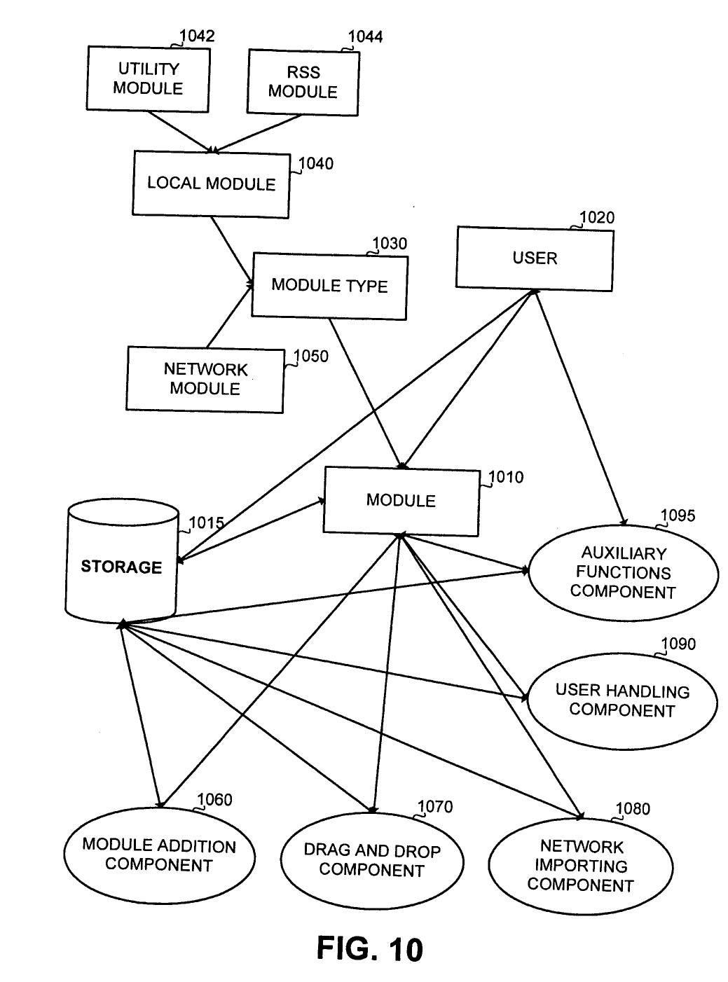

Referring now to FIG. 10, which shows the main components in a preferred implementation of the methods of the disclosed invention. This apparatus is preferably implemented by a computerized system, which enables object oriented environments, such as C++, C#, Java or any other. In the preferred embodiment, the basic unit is a module object 1010, which represents one object placed on a personalized web page of a specific user. In an alternative embodiment, module object 1010 can also represent a collection of objects placed on one or more personalized web pages. Each module object 1010 contains information relevant for the presentation of the object on the screen, including its title, its editing options, comprises information relevant for the placement of the module on the web page, such as the location, whether the module is expanded or collapsed, and the like. Each module object 1010 either contains, points at, or is otherwise related to a user object 1020. User object 1020 contains the identification, preferences, templates and other information related to the user. User object 1020 comprises a collection, such as an array, of the module objects contained on the user's personalized page. Module object 1010 further points at, derives from, or contains module type object 1030, which represents the type of the relevant module, and contains relevant information. Module type object 1030 can derive, inherit or otherwise relate to a local module type 1040, a network module type 1050, or another type. Local module type 1040 can be related to a utility module 1042, such as a calculator, a weather reporting module, a calendar, a search engine, a memo, or any other utility implemented as part of the apparatus. In the case of a utility module, object module 1010 will contain relevant information, such as the contents of the memo, the city for which the whether is reported, or the like. Local module type 1040 can also be related to RSS module type 1044. In this case, object module 1030 contains the address of the RSS source, the number of requested items, and the like. Alternatively, module type 1030 derives or inherits from a network module 1050. Network module 1050 relates to a component which consists of a fragment of the web page that is placed on the personalized web page, such as component 10 of FIG. 1. Network module 1050 comprises or otherwise has access to the locator, such as the URL of the relevant web page, and the coordinates of the selected fragment within the web page. The content of the web page itself is not a part of the system, and is loaded by the browser of the user directly from the web page. All the information about users 1020 and modules 1010 is stored in storage 1015. Storage 1015 is further detailed in association with server 200 of FIG. 2. The system further comprises components that implement the methods of the disclosed invention. The components can be implemented as stand-alone, web services, part of an object, part of an object-type, or in any other technique currently known or that will become known in the future. The components include module addition component 1060, which is responsible for enabling the user to choose a component from a predefined list, such as the utility modules, from an RSS feed suggested by the system or from any other source. Drag and drop component 1070 comprises the routines used when modules are moved around the personalized web page through dragging and dropping, dragged to or from the icon tray or the like. Network importing component 1080 is responsible for enabling the selection and submission of a fragment of a web page to the personalized web page, as detailed in association with FIGS. 5 and 6 above. User handling component 1090 comprises routines for adding, deleting, updating or otherwise handling the operations related to users of the system. Auxiliary functions component 1095 comprises general routines, such as database access and handling routines, security, and the like. Auxiliary functions component 1095 can further comprise routines or other code fragments for optimal placement of the components on the personalized web page, with or without horizontal or vertical grid lines. The routines supplied by Auxiliary functions component 1095 can be used by any component of the system, including but not limited to module addition component 1060, drag and drop component 1070 and network importing component 1080. All routines which belong to components 1060, 1070, 1080, 1090 and 1095 communicate with the relevant module objects 1010 and with storage 1015, so that the personalized web page, with the updated information relating the modules is stored after each operation of the user, and will therefore be loaded in the same configuration the next time the user accesses it, either from the same platform or from a different one. Preferably, the abovementioned objects are constructed and the components run on server 200 of FIG. 2, and accessed by any client, such as 204, 208, 210, or 212 of FIG. 2.

It will be appreciated by a person skilled in the art that this division to objects and implementation components is not mandatory, and many systems, such as C# provide the option, or even compel the implementer to implement a function within an object. The various data members and functionalities can be distributed in other manners between components of the system. For example, auxiliary routines can be implemented as parts of certain objects or other components, and not necessarily as an independent unit.

It will also be appreciated by a person skilled in the art that additional entities and operations have to be imported into the system or implemented as part of the apparatus, such as database handling, network communication, graphics, backup, security, or the like. However, such components are known in the art and implemented as a part of almost any network apparatus. Therefore they were omitted from the above description for clarity reasons.

The presented methods and apparatus enable a user to construct and use a personalized web page, comprising all the information he or she needs, including utilities, RSS feeds, relevant fragments of various web pages and others. The personalized web page can be accessed from multiple computing platforms, including cellular phones or handheld devices that enable surfing the internet, laptops and other platforms. However, each one of multiple users using the same computing platform will have his or her own personalized web page, constructed according to their own preferences and requirements. The personalized web page can comprise information in multiple languages, and update in predetermined refresh rates. The web page can be further transformed to be an active desktop of a user.

It will be appreciated by persons skilled in the art that the present invention is not limited to what has been particularly shown and described hereinabove. Rather the scope of the present invention is defined only by the claims which follow.

What is claimed is:

1. A method for constructing and using a personalized web page, the personalized web page comprising an at least one first module, the at least one first module is a fragment of a second web page having a locator, the second web page stored on a web site, the fragment identified by at least two coordinates within the second web page, wherein each coordinate comprises two numbers, the method comprising the steps of:
selecting the fragment of the second web page;
placing the at least one first module on the personalized web page; and
storing a description of the personalized web page on a storage device.

2. The method of claim 1 wherein the description of the personalized web page comprises the locator of the second web page and the at least two coordinates of the at least one fragment of the second web page, within the second web page.

3. The method of claim 1 wherein the locator of the second web page is a Unified Resource Locator.

4. The method of claim 1 further comprising the steps of:
retrieving the description of the personalized web page from the storage device;
loading the second web page; and
clipping the second web page according to the at least two coordinates of the at least one fragment of the second web page.

5. The method of claim 4 wherein the second web page is loaded from the web site.

6. The method of claim 1 wherein the personalized web page is a home page.

7. The method of claim 1 wherein the personalized web page is a personalized portal.

8. The method of claim 1 wherein the at least one first module can be collapsed or expanded or placed on an icon tray or retrieved from the icon tray.

9. The method of claim 1 wherein the at least one first module is refreshed at predetermined intervals.

10. The method of claim 1 wherein the personalized web page comprises an at least one second module.

11. The method of claim 10 further comprising the step of presenting the at least one second module on the personalized web page.

12. The method of claim 10 wherein the at least one second module is a utility.

13. The method of claim 12 wherein the utility is one of the group consisting of: a clock; a world clock; a calendar; a holiday and special times utility; a chat tool; a radio-like or TV-like tool; a media guide; a bills payment service; a postal delivery service; a price comparing tool; a phone directory; an SMS or MMS sending tool; a translator or a trans-literature tool; a downloading tool; a weather reporting tool; a calculator of any type, including a scientific calculator, an economics calculator and others; an e-mail checking utility; a maps utility; a currency exchange and conversion rates tool; a memo pad; a search engine; a stock quote tool; or a domain-specific utility.

14. The method of claim 10 wherein the at least one second module is an RSS feed.

15. The method of claim 10 wherein the at least one second module can be collapsed or expanded or placed on an icon tray or retrieved from the icon tray.

16. The method of claim 10 wherein the at least one second module is refreshed at predetermined intervals.

17. The method of claim 1 wherein the personalized web page is used as an active desktop.

18. The method of claim 1 wherein the personalized web page is viewed from a platform, the platform is of the group consisting of: a personal computer; a network computer; a laptop computer; a handheld device; or a cellular phone.

19. An apparatus for constructing and presenting a personalized web page, the personalized web page comprising an at least one first module, the at least one first module is a fragment of a second web page having a locator, the fragment identified by at least two coordinates within the second web page, wherein each coordinate comprises two numbers, the apparatus comprising:
a storage device for storing the locator of the second web page and the at least two coordinates; and
a server platform, the server platform comprises:
a network importing component for selecting and submitting the locator of the second web page and the at least two coordinates of the fragment of the second web page to the personalized web page; and
a module addition component for adding the at least one first module to the personalized web page.

20. The apparatus of claim 19 wherein the server platform further comprises a component for enabling drag and drop operations.

21. The apparatus of claim 19 wherein the server platform further comprises a component for handling operations related to an at least one user of the apparatus.

22. The apparatus of claim 19 wherein the locator of the second web page is a Unified Resource Locator.

23. A computer readable storage medium containing a set of instructions for a general purpose computer, the set of instructions comprising:
a selection component for selecting a fragment of a first web page;
a placement component for placing the fragment of the first web page on a personalized web page; and
a storage component for storing a description of the personalized web page on a server.
